(19) United States
(12) Patent Application Publication
(10) Pub. No.: US 2025/0116840 A1
(43) Pub. Date: Apr. 10, 2025

(54) METHOD AND SYSTEM FOR REDUCING ACTUATION FORCES FOR AN ADJUSTABLE OPTICAL ELEMENT

(71) Applicant: Optotune Switzerland AG, Dietikon (CH)

(72) Inventors: Roman Patscheider, Dietikon (CH); Erik Hebestreit, Dietikon (CH); Wolfgang Zesch, Dietikon (CH)

(73) Assignee: Optotune Switzerland AG, Dietikon (CH)

(21) Appl. No.: 18/904,107

(22) Filed: Oct. 2, 2024

(30) Foreign Application Priority Data
Oct. 5, 2023 (DE) 10 2023 127 210.1

(51) Int. Cl. G02B 7/02; G02B 3/12

(52) U.S. Cl. CPC G02B 7/023; G02B 7/026; G02B 3/12

(57) ABSTRACT

The invention relates to a multi-phase actuation method for adjusting an optical element comprising a plurality of actuators, wherein the method comprises the steps of: Determining an end position for each actuator to which each actuator is to be actuated for adjusting the optical element; In a first actuation phase, driving at least two or more actuators of the plurality of actuators to a first actuation position; in a second actuation phase, driving all actuators that have not reached their associated end position to their associated end position, wherein at least one of the two or more actuators reverses its drive direction to reach its associated end position(s), such that the optical element arrives in its adjusted state.

### FIELD

The invention relates to a multi-phase actuation method and computer program, as well as an adjustable optical system.

### BACKGROUND

Adjusting an optical element such as a membrane-based liquid lens or other adjustable optical elements, such as a pixel shifter, based on bending, moving or deforming at least one surface of the optical element is typically achieved by one or more actuators that are driven against some kind of restoring force in order to adjust the optical element.

The required actuation force depends on the specific geometry, components and design of the optical element. The higher the restoring forces the higher the actuation forces of the actuators need to be. However, high actuation forces are energy- and force consuming and therefore might require comparably large actuators.

It is an ongoing objective to build energy-efficient and small actuators configured to generate high actuation forces. These objectives, however, have a diametral opposite impact on the actuators. Small actuators are not capable to generate high actuation forces, and vice versa.

As many optical applications are battery-driven and built space in optical devices, such as mobile phones or glasses, is a valuable resource, there is a need to provide compact optical elements or systems that unite all the above properties, i.e. optical elements requiring only a small built space, that are energy-efficient and that provide a high degree of optical adjustment, e.g. in terms of a focal length, which in turn requires comparably high actuation forces due to the underlying high bending modules.

It is therefore an object of the present invention to provide a method, a computer program as well as a system for multiphase actuation of an adjustable optical element. The object is achieved by the methods, computer programs, and systems described herein in the independent and dependent claims.

### SUMMARY

According to a first aspect of the invention, a multi-phase actuation method for adjusting an optical element comprising a plurality of actuators, comprises at least the steps of:
Determining an end position for each actuator to which each actuator is to be actuated for adjusting the optical element to an adjusted state,
In a first actuation phase, driving at least two or more actuators of the plurality of actuators to a first actuation position, particularly such that the optical element arrives in an intermediate state, particularly wherein at the end of the first actuation phase the optical element is not in its adjusted state,
In a second actuation phase, driving all actuators that have not reached their associated end position to their associated end position, wherein at least one of the two or more actuators reverses its drive direction to reach its associated end position(s), such that the optical element arrives in its adjusted state.

The method allows for adjusting an optical element with actuators, particularly wherein a greatest actuation force that would need to be generated by single actuator to overcome a corresponding restoring force may be reduced by having two or more actuators actuating unitedly against said greatest restoring force instead only the actuator that would experience said restoring force. Once this task is achieved or almost achieved (at the end of the first actuation phase), at least one of the two or more actuators reverse(s) its/their actuating direction in order to drive to their associated end position.

In simple words, one embodiment comprised by the invention relates to a situation in which a single actuator would experience a comparably high restoring force at its associated end position. The method provides that instead having only this actuator drive to or toward said end position, several actuators drive to said end position, thereby collectively reducing required actuation force required to overcome the restoring force that is exhibited on the one actuator. Once this task is achieved, the several actuators drive to their associated end position. This way, actuation forces required from single actuators are reduced, which in turn allows to implement actuators that exhibit lower maximum actuation forces, which in turn allows using smaller actuators. The method may be more energy efficient than methods that directly drive each actuator to its end position, as maximum actuation forces are omitted.

The method allows actuation for a given optical element with actuators that are designed to generate up to 20% less actuation force.

The actuators may be selected from one or more of the group consisting of:
a stepper motor,
a direct drive motor,
a magnetic reluctance force motor,
an electrostatic force motor,
a voice coil actuator

a piezo actuator

a SMA (shape-memory alloy) actuator.

Particularly, the plurality of actuators may comprise 2, 3, 4, 5, 6, 7, 8, 9, 10,11,12,14, or 16 actuators.

Actuation forces of each actuator may be in the range of −5N to 5N, particularly −2.5N to 2.5 N, more particularly −1N to 1N, even more particularly 0N to 1N.

The magnitude of actuation forces may be in the range from 0.5N to 10N.

Particularly, the actuators may be designed to generate a holding force that is greater than the actuation force. For example, the actuators may be designed to generate a holding force that is approximately 50% higher than a greatest actuation force.

According to another embodiment of the invention, the plurality of actuators comprises not more than 12 actuators, particularly not more than 11,10,9,8,7,6,5,4,3 or 2 actuators.

According to another embodiment of the invention, the plurality of actuators comprises at least between 2 and 10 actuators, particularly at least 3,4,5,6,7,8, or 9 actuators.

According to another embodiment of the invention, at least some, particularly all actuators of the plurality of actuators are in contact with the optical element or via a/the restoring force generative element at different contact locations at which the actuators bring in their actuation force. Further, actuation forces exerted at one contact location may be distributed to other contact locations by the optical element such that a restoring force acting at one contact location may be countered and/or overcome by one or more actuators at a different contact location.

This allows for energy- and force-efficient adjusting of the optical element, despite potentially high restoring forces at one contact location.

Particularly, the actuators are configured and arranged to actuate at least an adjustable portion of the optical element, wherein the actuators are in contact with the optical element at different contact regions.

The actuators may be in contact with one or more shaping elements configured to shape an optical surface of the optical element by exerting a force on the optical element. Alternatively, or additionally, the actuators may be in contact with springs that are configured and arranged to adjust the optical property of the optical element.

Determining the end position for each actuator may be achieved by reading a current position of the actuator and determining an end position in order to arrive at the desired adjusted state of the optical element.

The determination of the end positions may be facilitated by means of a processor, a control module, and/or a data processing system.

It is noted that in the context of the current specification the notion of an actuator moving, driving, being driven, being moved or actuated to a position refers to the process of actuation and not the actuator itself being moved as a whole.

Particularly, the actuators are actuators configured to actuate back and forth along on direction only.

Particularly, during the first actuation phase the two or more actuators are actuated simultaneously or quasi-simultaneously with a short delay.

Particularly, the at least two or more actuators have an associated first position; that is, each of the two or more actuators may have associated its own first position.

According to another embodiment of the invention, the first position is the same position for all actuators.

According to an alternative embodiment of the invention, the first positions associated to at least some or all of the actuators differ from each other.

Particularly, in each state, the optical element generates a cumulative restoring force that is distributed amongst the plurality of actuators, particularly via the contact locations and the adjustable portion, such as the shaping element, wherein each actuator is subjected to a restoring force that amounts to a fraction the cumulative restoring force.

This way, a restoring force acting on the two or more actuators at the first position is distributed amongst said two or more actuators. This in turn allows that each actuator requires a lower actuation force to reach the first position.

Thus, the adjustable portion may transmit or generate a restoring force of the optical element, which may be distributed to different contact locations. The restoring force may also be bending force or moment originating from a bending module of a force generative element, such as a membrane. The bending force may be generated by bending or deforming the adjustable portion of the optical element.

It is noted that after the first actuation phase, the optical element is not in its intended adjusted state, but in an intermediate state, wherein after the second actuation phase, particularly only after the second actuation phase the optical element is in its adjusted state.

Particularly, the method comprises the steps of adjusting the optical element from a first adjusted state to a second adjusted state. The method starts in the first adjusted state, in which the end positions are determined, then the first actuation phase is executed, wherein after the first actuation phase, the optical element is neither in the first nor in the second adjusted state, but in an intermediate state. Then the second actuation phase is executed, wherein after the second actuation phase the optical element is in the second adjusted state.

In other words, the method provides that determining the end position is initiated at the first adjusted state, then the first and the second actuation phases are executed in order to (and only after the second actuation phase) arrive at the second adjusted state.

According to another embodiment of the invention, after the second actuation phase, a restoring force acting on at least one actuator of the plurality of actuators that is actuated closest to or actuated at the first position is higher than a restoring force acting on at least one other actuator at its associated end position.

This embodiment provides that at or close to the first position a restoring force may be higher than at a different position. Thus, the method provides actuation support for at least one actuator, thereby reducing a required actuation force, as at least two actuators are driven toward or to the first position. The first position may correspond to the end position of an actuator that would have required a higher actuation force if driven alone to said first/its end position.

According to another embodiment of the invention, after the second actuation phase, a restoring force acting on at least one actuator of the plurality of actuators that is actuated closest to or actuated at the first position is higher than a restoring force acting on at least two, three or more actuators of the plurality of actuators at their respective end positions, particularly wherein after the second actuation phase, a restoring force acting on at least one actuator of the plurality of actuators that is actuated closest to or actuated at the first position is higher than a restoring force acting on 25%, 50%, or 75% of all actuators at their associated end positions.

According to another embodiment of the invention, wherein the restoring force acting on the at least one actuator of the plurality of actuators that is actuated closest to or actuated at the first position is higher than the restoring force acting any other actuator at its associated end position.

This embodiment allows reducing a required actuation force for the at least one actuator that is to actuated closest to or to the first position, by actuating at least one more actuator toward the first position. As the restoring force at the first position is higher than the restoring forces at any other end position, this embodiment is particularly, force and energy-saving.

According to another embodiment of the invention, the restoring force is a spring force.

According to another embodiment of the invention, a driving direction of the plurality of actuators extends along a first axis, particularly wherein the driving direction of the plurality of actuators is oriented along an optical axis of the optical element. Particularly, the first direction corresponds to the optical axis of the optical element.

According to another embodiment of the invention, the optical element is a liquid lens or an adjustable window element.

A liquid lens may particularly be a membrane-based liquid lens, i.e. a liquid lens with a liquid reservoir, wherein at least one optical surface of the liquid lens extends over said reservoir, wherein a shape, particularly a curvature of the membrane may be adjusted by increasing or decreasing a pressure exerted from the liquid onto the membrane. Adjusting the pressure may be done by driving the actuators.

The adjustable window element may be comprised in an adjustable beam shifting or beam deflection device, such as a scanner, a pixel-shifter of an imaging system, or a prism device.

By tilting or moving the window by means of the actuators the optical element comprising the window may be adjusted for an optical property.

According to another embodiment of the invention, the plurality of actuators is arranged along a circumference portion of a clear aperture of the optical element, particularly such that the contact locations are arranged along the circumference portion of the clear aperture of the optical element.

According to another embodiment of the invention, one or more shaping elements are arranged along said circumference portion, wherein the actuators are configured to move or deform said one or more shaping elements for adjusting the optical element.

The one or more shaping elements may be a annular element with a clear aperture in its center, or shaping elements forming portions of an annular or ring-shaped element. The one or more shaping element may be circular, partially circular, oval, partially oval or polygonal. The one or more shaping elements may be configured to facilitate force transmission of the actuators to the optical element and its adjustable portion. The one or more shaping elements may serve the only purpose to facilitate durable contacting of the actuators with the optical element.

According to another embodiment of the invention, in the adjusted state of the optical element, a contour of the one or more shaping elements varies along the first axis in the adjusted state of the optical element.

That is, the one or more shaping elements may be deformed by the actuators such as that the one or more shaping elements exhibit a height-varying (i.e. varying along the first axis) contour around the clear aperture of the optical element.

According to another embodiment of the invention, one or more actuators, particularly all actuators exhibit a load- and/or an actuation position-dependent actuation force characteristic, particularly wherein the actuation force is non-linear with respect to the load and/or the actuation position.

This embodiment provides for the case, when the actuators may not exhibit a linear or almost linear actuation characteristic, but a strongly non-linear characteristic. For example, magnetic actuators may have particularly weak actuation forces at certain actuation states that increase or decrease non-linearly with the actuation position due to the nature of the magnetic force driving the actuator

Thus, energy-consumption and maximum actuation force requirements are particularly well-addressed by the method in case any non-linear actuation characteristic or non-linear restoring force characteristic is present at the optical element or the actuators.

According to another embodiment of the invention, the restoring force is non-Hookean, i.e. non-linear-elastic.

This embodiment benefits in the same manner from the method according to the invention as elaborated for the previous embodiment.

According to another embodiment of the invention, all or at least multiple restoring forces acting on the actuators are coupled via the optical element, particularly via the adjustable portion, in particular via the one or more shaping elements, such that the actuators collaboratively work against the coupled restoring forces at least during the first actuation phase.

According to another embodiment of the invention, a holding force of each actuator is higher than a highest achievable actuation force of each actuator.

The highest achievable actuation force corresponds to the maximum design actuation force of the actuator.

The holding force of an actuator may be generated by different means the actuation force, e.g. by means an inhibition element that locks the actuator in its actuated state.

This embodiment allows to adjust the optical element with the method into states that would not be accessible by driving the actuators conventionally, i.e. directly (i.e. omitting the first actuation phase) to the adjusted state without the joint first actuation phase actuation.

According to another embodiment of the invention, a holding force of a/the actuator is higher than a highest achievable actuation force of a/the actuator.

According to another embodiment of the invention, the optical element is a membrane-based fluid or liquid lens, wherein in the first actuation phase, particularly only in the first actuation phase, a sphere power of the fluid lens is adjusted, wherein in the second actuation phase, particularly only in the second actuation phase, a cylinder power of the fluid lens id adjusted.

According to a second aspect of the invention a computer program comprising computer program code is disclosed, wherein when the computer program is executed on a data processing system, such as a computer or/and a controller, the computer program causes the data processing system to execute the method according to first aspect, particularly by causing the data processing system to issue control signals configured to drive the actuators according to the method of invention.

According to a third aspect of the invention, an adjustable optical system is disclosed, the system comprising at least the components:
an optical element with a plurality of actuators,
a base frame,
at least one restoring force generative element,
wherein the actuators are arranged to exert an actuation force between the base frame and the at least one restoring force generative element, such that the optical element is adjusted,
a control module configured to drive the actuators according to the method according the invention.

It is noted that embodiments, single, several or combined features and/or definitions provided and elaborated on the context of the method or the computer program are applicable in the same or analogue fashion to the system and vice versa.

For example, the actuators may be arranged and configured as elaborated in the context of the method.

The term “adjusting the optical element” particularly refers to adjusting an optical property of the optical element by means of a mechanical adjustment of the optical element facilitated by the actuators.

The base frame in essence serves as a platform for providing a counterforce to the restoring and actuation forces, such that upon actuation of the actuators the optical property of the optical element is adjusted.

According to another embodiment of the invention, the control module is connected to a data processing system to receive and to execute control signals from the control module, the data processing system having stored the computer program according to the invention.

Connection may be achieved wirelessly. That is, while the control module may be arranged on the system the data processing system may located elsewhere.

It is possible that the data processing system is located at or comprised by the control module.

The data processing system, may be a computer, a distributed computing system or a processor.

According to another embodiment of the invention, the at least one restoring force generative element, comprises a bellows and/or one or more elastically deformable membrane(s).

According to another embodiment of the invention, the plurality of actuators is arranged along a circumference portion of a clear aperture of the optical element.

According to another embodiment of the invention, the system comprises one or more shaping elements that are arranged along the circumference portion of the clear aperture, wherein the one or more shaping element(s) is/are in contact with the actuators.

As elaborated in the context of the first aspect of the invention, the shaping element(s) may possess various shapes and geometries and serve various purposes.

According to another embodiment of the invention, the system comprises an elastically deformable membrane covering a fluid core, particularly a liquid core, wherein the system is configured to adjust a shape of the elastically deformable membrane with the actuators, particularly by means of moving and/or deforming the one or more shaping elements, thereby adjusting an optical property of the optical element.

This embodiment allows for particularly compact fluid core devices with high optical powers and/or high bending moments of the membrane that typically evoke high restoring forces and thus require high actuation forces.

According to another embodiment of the invention, the one or more shaping element(s) is/are attached to the elastically deformable membrane at the circumference portion of the clear aperture.

According to another embodiment of the invention, the system comprises a fluid lens comprising the elastically deformable membrane, wherein said membrane is adjustable with the actuators for adjusting an optical property, such as an optical power of the fluid lens.

This embodiment allows for a particularly compact fluid lens with high optical powers and/or high bending moments

According to another embodiment of the invention, the system comprises one or more inhibition elements that is/are configured to generate a holding force, wherein each inhibition element is configured to lock an associated actuator in an end position or in the first position and to sustain a holding force at said position.

This embodiment allows for a compact optical element exhibiting high restoring forces.

### BRIEF DESCRIPTION OF THE DRAWINGS

Particularly, exemplary embodiments are described below in conjunction with the Figures. The Figures are appended to the claims and are accompanied by text explaining individual features of the shown embodiments and aspects of the present invention. Each individual feature shown in the Figures and/or mentioned in said text of the Figures may be incorporated (also in an isolated fashion) into a claim relating to the device according to the present invention.

FIG. 1, Panels A) to C) depict a first embodiment of the method according to the invention;

FIG. 2 Panels A) to C) depict a second embodiment of the method according to the invention;

FIG. 3 Panels A) to C) depict a third embodiment of the method according to the invention;

FIG. 4 Panels A) to C) depict a fourth embodiment of the method according to the invention; and

FIG. 5 Panels A) and B) show a system according to the invention.

### DETAILED DESCRIPTION

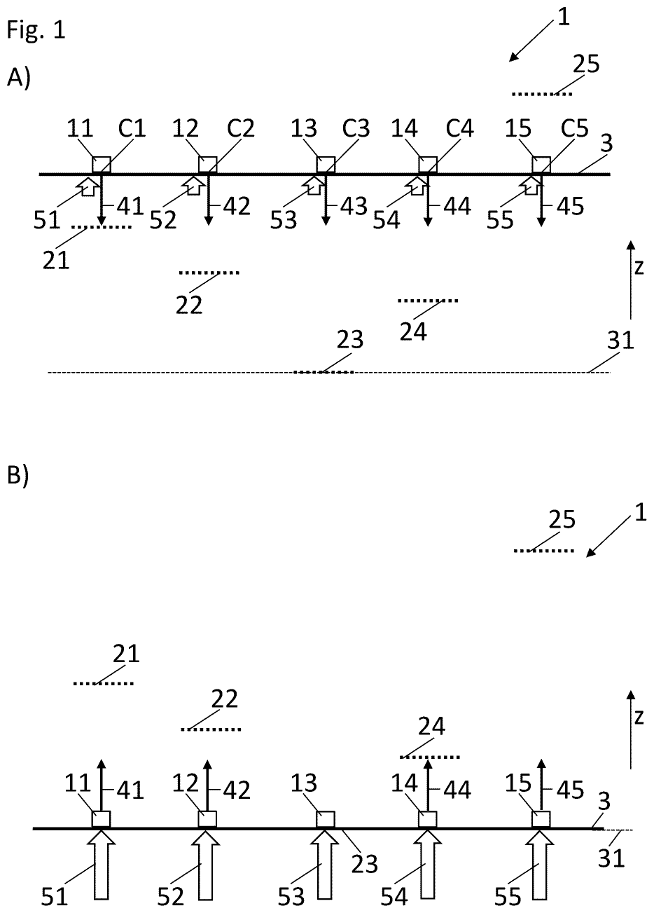

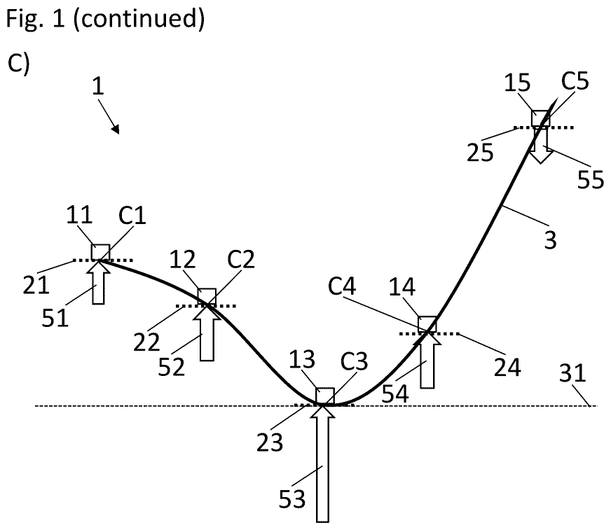

In FIG. 1 a first example of the method according to the invention is shown. Without loss of generality, the optical element 1 comprises five actuators 11, 12, 13, 14, 15 that are attached at different contact locations c1, c2, c3, c4, c5 to an adjustable portion of the optical element 1, in this example it may be an elastically deformable membrane 3 of a liquid lens. FIG. 1A in essence depicts a situation in which the end positions 21,22,23,24,25 for each actuator 11,12,13,14,15 have been determined. Further, the first position 31 has been determined as well. In this example, the first position 31 is the same (in term of its position along the first axis z) for all actuators 11,12,13,14,15 and corresponds to the end position 23 of actuator 13. The situation depicted in FIG. 1A may correspond to a first adjusted state of the optical element, wherein it is the goal to adjust the optical element so as to adopt a second adjusted state.

In the example, it may be that a restoring force at position 23, is highest compared to the remaining end positions 21, 22, 24, 25.

In this example, the method provides that in a first actuation phase, two or more—in the example all actuators are driven to the first position 31 simultaneously. It is noted that this state corresponds to an intermediate state of the optical element that does not correspond to the intended second adjusted state of the optical element. A restoring force at position 23 is distributed to the adjacent actuators via the optical element 1, e.g. the membrane corresponding to the adjustable portion of the optical element. In turn, actuation forces of the actuators may counteract the restoring force at position 23, which allows actuator 13 to generate a lower actuation force as compared to a situation, in which this actuator 13 may be driven alone to its end position 23, not being support by the other actuators. Once arrived (cf. FIG. 1B) at the first position 31, in a second actuation phase, the actuators 11,12,14,15 that have not reached their end position reverse their drive direction 41,42,44, 45 and drive toward their associated end position 21,22,24,25, which may be support by the restoring forces pointing in the same direction and thus requires only little actuation forces. The second adjusted state of the optical element 1 is depicted in FIG. 1C. This second adjusted state may correspond to “the adjusted state” in the claims and portions of the description.

A restoring force acting on the actuator 13, may be higher than a greatest actuation force the actuator 13 is designed to generate. In order to fix said actuator 13 at its end position 23, the actuator 13 may exhibit a holding force that is higher than its greatest generatable actuation force.

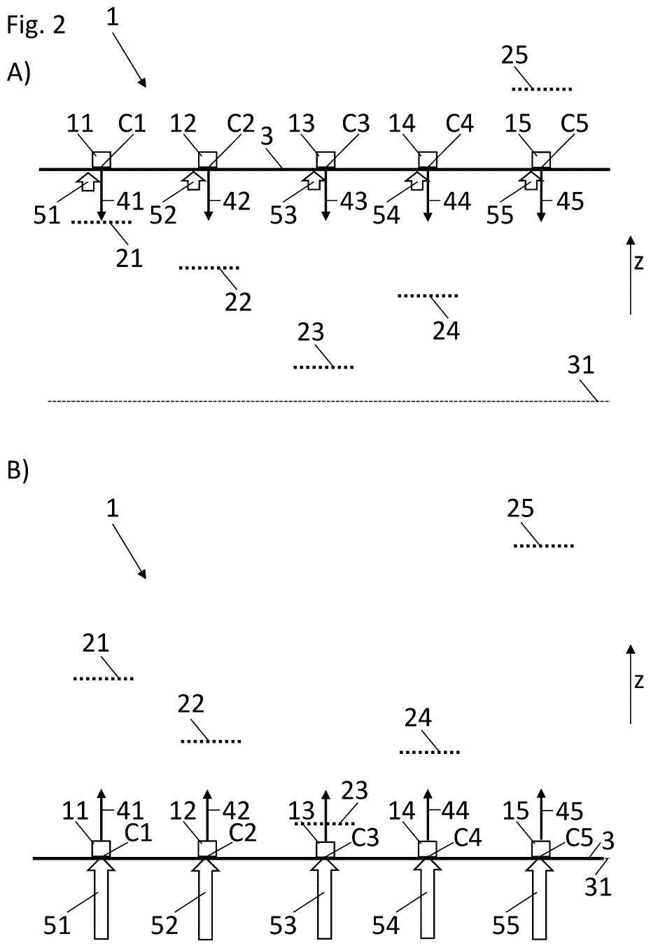

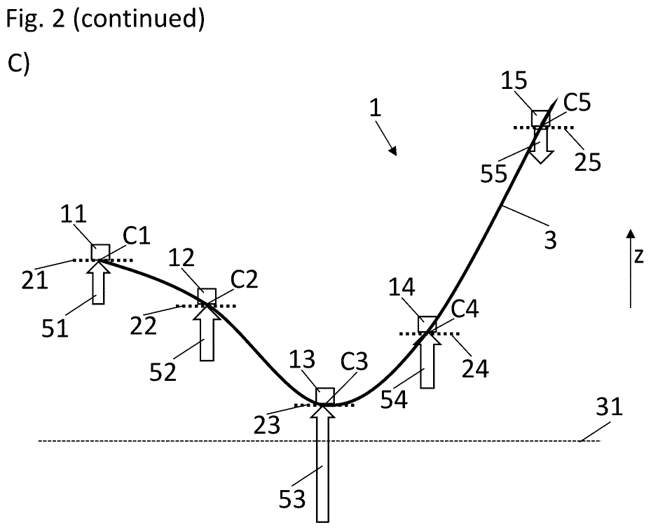

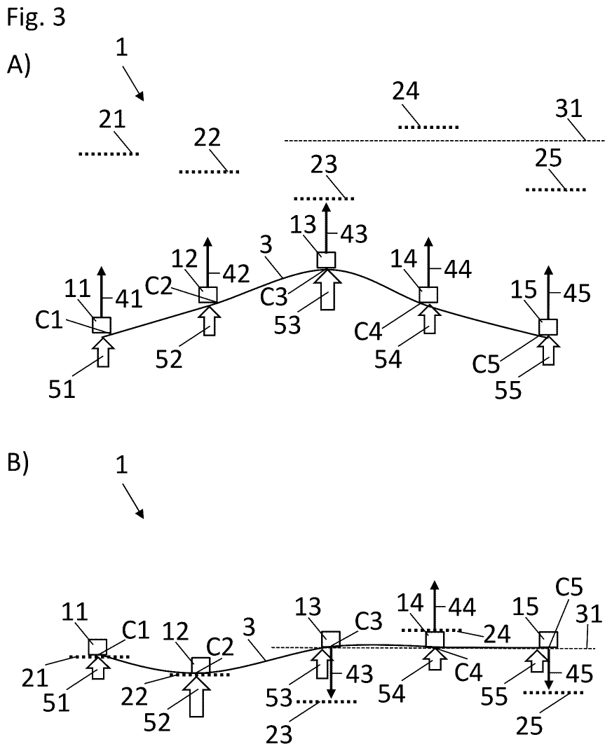

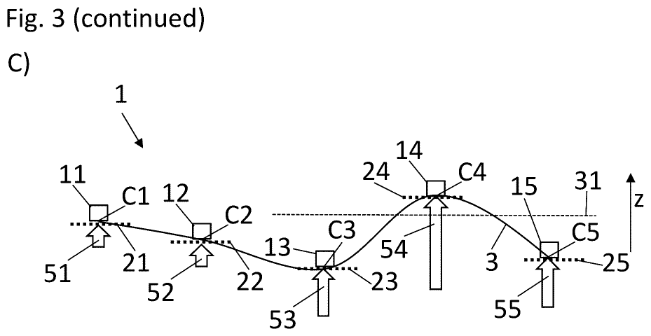

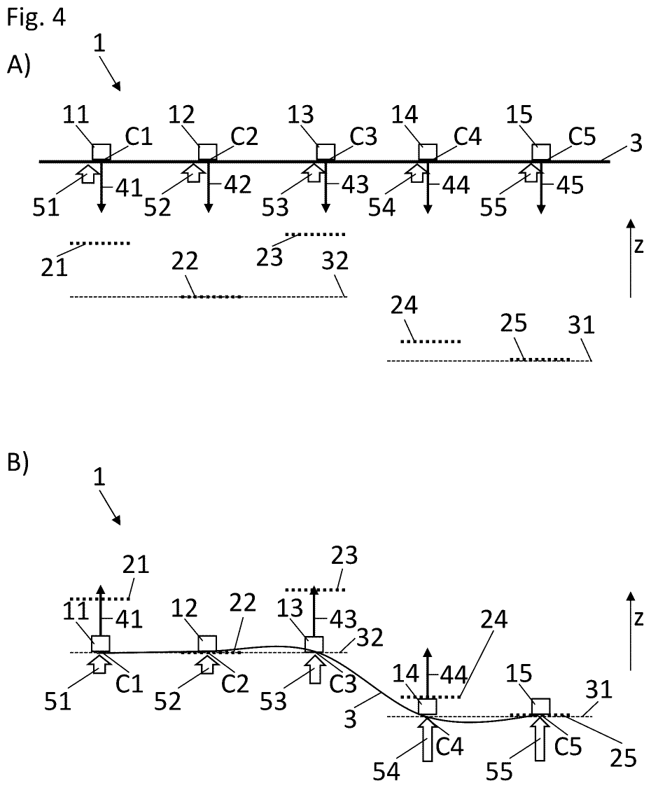

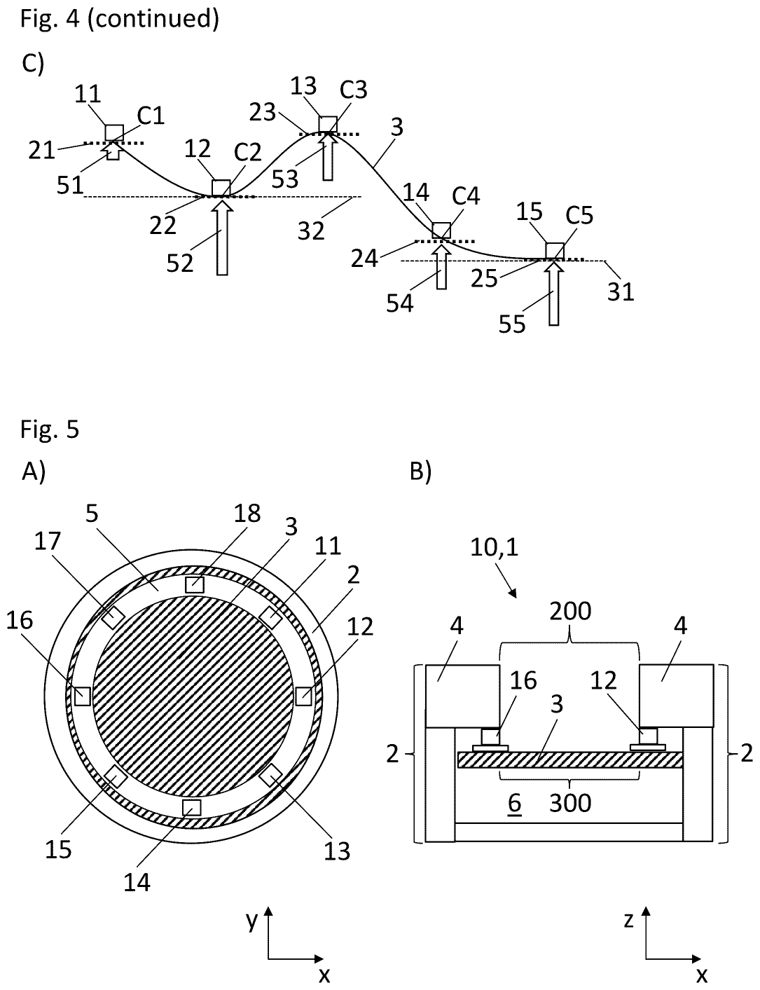

In FIG. 2, a similar situation is depicted as in FIG. 1. For reasons of interlegibility, only the differences between the embodiments shown in FIGS. 1 and 2 are elaborated, wherein definitions and terms that are applicable to both embodiments are not repeated, but may nonetheless apply for the embodiment shown in FIG. 2. The same holds true for the FIGS. 3 and 4.

In contrast to FIG. 1, the first position 31 does not correspond to any end position of the actuators, but is located only close to the end position 23. In FIG. 2A the drive directions of all actuators point toward the first position and the actuators are consequently driven to the first position simultaneously. Once arrive at the first position (cf. FIG. 2B), the drive directions of all actuators reverse to drive the actuator toward its associated end positions. This embodiment may be suitable for situations in which the intermediate state, i.e. after the first actuation phase, is used to reference and/or control the positions of the actuators. This embodiment may be also advantageous, in cases where the actuators exhibit a hysteresis in their control behavior or in case the generated actuation forces are strongly non-linear with position. In these scenarios it may be necessary or advantageous to drive the actuators during the second actuation phase only in direction of the restoring force and not against it.

FIG. 3 depicts a different exemplary embodiment of the invention. In FIG. 3A the actuators adopt a first adjusted state and the end positions of the actuators as well as the first position 31 have been determined.

In this example, while the restoring forces may point toward the drive direction as indicated in FIG. 3A, it may be conceivable that a bending moment of the adjustable portion of the optical element 1 depends on a radius of curvature and thus is particularly high for actuator 14, as a radius of curvature of the membrane 3 in the adjusted state (FIG. 3C) is smallest at the end position 24.

In order to support actuator 14, actuators 13,14 and 15 are driving to the first position during the first actuation phase, wherein actuators 11 and 12, are directly driving to their associated end positions 21,22. This is depicted in FIG. 3B, it is noted that the radius of curvature of the adjustable portion at the first position for actuators 13,14, 15 is comparably low in the intermediate state of the optical element.

During the second actuation phase, actuators 11, 12 do not move but remain at their end position, wherein actuators 13 and 15 reverse their drive direction. Actuator 14 drives onward its end position 24 The effect of the motions of actuators 13,14 and 15 is that the radius of curvature and thus the restoring force that is evoked by bending the adjustable portion is collectively generated and counteracted by the actuators 13,14, 15, thereby reducing the individual actuation force required to arrive at the adjusted state of the optical element in FIG. 3C.

It is noted that it may be advantageous to first drive actuator 14 to its end position 24 and then drive actuators 13 and 15 to their associated end positions 23 and 25 during the second actuation phase.

This example demonstrates that the depending on the specific origin of the restoring forces and the specific properties of the optical element (here bending module), the method allows actuation with reduced force-requirements.

In FIG. 4 an example is depicted in which two different first positions are determined. Actuators 11, 12,13 are determined to drive to one first position 32, wherein the actuators 14,15 are determined to drive toward another first position 31 during the first actuation phase (cf. FIG. 4A). This may be advantageous when restoring forces (due to a bending moment and/or a spring-like restoring force) at different locations require two actuators to be supported by at least one more actuator. Specifically, actuator 12 is supported by two actuators 11,13, wherein actuator 15 is supported by only one more actuator 14.

As can be seen in FIG. 4B, three actuators 11,13,14 reverse their drive direction after the first actuation phase to arrive at their associated end positions. In FIG. 4C the adjusted state of the optical element is depicted, in which all actuators have arrived at their associated end positions. It is conceivable that a restoring force at the position of actuator 12 may be composed of a bending moment (due to curvature of the adjustable portion at the end position 22) and a spring-like force that points along the first direction z, wherein the restoring force at the end position 25 of actuator 15 is mainly composed of a spring-like force and less of a bending moment, as the radius of curvature is comparably high at end position 25.

FIG. 5 schematically depicts a system according to the invention. FIG. 5A shows a cross-section like top view of the system along an x- and y-axis, wherein FIG. 5B depicts the corresponding cross-sectional view of the system along a z-axis, that corresponds to the first direction z.

The optical system comprises a force generative element 3 in form of a distensible membrane. The system further comprises a container that comprises a base frame 2 as well as a transparent bottom portion 7. Opposite the transparent bottom portion 7 the membrane seals off a liquid comprised in the container, such that the optical system comprises a fluid core 6.

The system 10 further comprises a shaping element 5 in form of a ring that is deformable along the z-axis. The shaping element is arranged along a circumference portion 201 of the membrane and allows the actuators 11-18 of the system to be attached to the membrane via said shaping element. The actuators are configured to push and/or pull the shaping element at their respective contact locations c1-c8 along the z-direction such as to deform the shaping element and thus to locally push and/or pull the membrane toward or away from the transparent bottom portion. This allows to adjust an optical power of the system and to compensate and/or generate higher order optical effects such as cylinder, sphere etc.

The system in this example comprises eight actuators, however, the number of actuators not limiting the invention. The inventions may comprise systems with two, three, four, five, six, seven eight, nine, ten, eleven, twelve, or sixteen actuators.

The actuators are controlled by a control module 4 that may be connected to a data processing system (not shown) that is configured to execute the method according to the invention on the optical system. The control module may comprise the computer program or portions of the computer program to execute the method and may provide power to the actuators such that the actuators move accordingly.

The example in FIG. 5 in essence refers to a fluid lens, but other optical system could be likewise configured to execute the method while comprising a force generative element, actuators, base frame and control module etc.

The fluid core may comprise an incompressible transparent liquid. Therefore, when the actuators are moved toward the transparent bottom portion the distensible membrane will be deformed in the area of the clear aperture and will form a lens surface. The radius of curvature depends on the amplitude of the actuation. The closer the actuators are driven toward the bottom portion the higher a restoring force will become that points against the drive direction. Similarly, in case the actuators are driven away from the bottom portion the membrane will bend in the reverse direction and a restoring force in the other direction will be evoked. In any case, for small radii of curvatures, the method according to the invention may allow to achieve such small radii without increasing the size/power of the actuators.

In order to determine the end positions and in particular the first position(s), the control module may have a database comprising information on the specific optical system. The information may allow the control module to determine the end and first position(s), e.g. by a look-up table, a formula that is evaluated based on first and second adjusted state and or by means of pre-set states of the optical element.

A simulation of an optical element has yielded to following actuation forces. Table 1 shows a simulation of an optical element having eight actuators (11-18), wherein the end positions are given

The end positions are given in the second line of the table, wherein the restoring forces that act on each actuator at their end position are given in the line restoring force. In case each actuator would be directly driven to the end position the restoring force would correspond to the required actuation force of the actuator. That is in table 1 in essence the required actuation forces are provided for each actuator if each actuator would directly drive to its end position, without executing the method of the invention. The maximum restoring force is about −1N for actuator #5.

TABLE 1

| Actuator # | 1 | 2 | 3 | 4 | 5 | 6 | 7 | 8 |
|---|---|---|---|---|---|---|---|---|
| End | −2.1 mm | −1.1 mm | 0.0 mm | −0.9 mm | −2.4 mm | −1.1 mm | 0.1 mm | −1.1 mm |
| position | | | | | | | | |
| Restoring | −0.60N | −0.33N | −0.04N | −0.07N | −0.96N | −0.30N | 0.38N | −0.63N |
| force | | | | | | | | |

In contrast, if the method according to the invention is executed on the same system as shown in Table 2, in the first actuation phase all actuators are driven to the first position, which corresponds to a stroke of −2.4 mm and thus to the position to which actuator #5 needs to be driven. The restoring force acting on actuator #5 amounts only to approximately −0.6N, wherein the highest restoring force acting on any of the actuators is only −0.76N. that means that the actuator #5 needs to generate only an actuation force of 0.6N to arrive at its end position instead of 1N.

In the second actuation phase, the remaining actuators #1,2,3,4,6,7,8 may be driven form the first position at −2.4 mm to their respective end positions, at which the restoring forces are anyway lower. While during the second actuation phase the restoring force at actuator #5 increases back to −1N, this is a marginal issue, as holding forces of actuators are typically higher than actuation forces. Particularly, the holding force of actuator #5 is higher than 1N. The method according to the invention allows to for lower actuation forces and thus for a more compact optical system, if the system is configured to execute the method.

TABLE 2

| Actuator # | 1 | 2 | 3 | 4 | 5 | 6 | 7 | 8 |
|---|---|---|---|---|---|---|---|---|
| Stroke | −2.4 mm | −2.4 mm | −2.4 Mm | −2.4 mm | −2.4 mm | −2.4 mm | −2.4 mm | −2.4 mm |
| Actuation | −0.76N | −0.62N | −0.73N | −0.74N | −0.62N | −0.67N | 0.72N | −0.66N |
| force | | | | | | | | |

The invention allows adjustment of optical elements in an energy- and force-conserving fashion.

### REFERENCE NUMERALS

1 optical element
2 base frame
3 force generative element/membrane
4 control module
5 shaping element
6 fluid core
7 transparent bottom portion
10 optical system
11,12,13,14,15,16,17,18 actuator
21,22,23,24,25 end position
31,32 first position
41,42,43,44,45 drive direction
51,52,53,54,55 restoring force
200 clear aperture
300 circumference portion
c1,c2,c3,c4,c5 contact location
Z first axis

1. A multi-phase actuation method for adjusting an optical element (1) comprising a plurality of actuators (11,12,13,14,15,16,17,18), wherein the method comprises the steps of:
Determining an end position (21,22,23,24,25) for each actuator (11,12,13,14,15,16) to which each actuator (11,12,13,14,15,16) is to be actuated for adjusting the optical element (1),
In a first actuation phase, driving at least two or more actuators of the plurality of actuators (11,12,13,14,15,16) to a first actuation position (31,32),
In a second actuation phase, driving all actuators that have not reached their associated end position (21,22,23,24,25) to their associated end position (21,22,23,24,25), wherein at least one of the two or more actuators reverses its drive direction (41,42,43,44,45) to reach its associated end position(s), such that the optical element (1) arrives in its adjusted state.

2. The method according to claim 1, wherein after the second actuation phase, a restoring force (51,52,53,54,55) acting on at least one actuator that is actuated closest to or actuated at the first position is higher than a restoring force acting on at least one other actuator at its associated end position.

3. The method according to claim 2, wherein the restoring force acting on the at least one actuator that is actuated closest to or actuated at the first position is higher than the restoring force acting any other actuator at its associated end position.

4. The method according to claim 1, wherein the restoring force is a spring force.

5. The method according to claim 1, wherein a driving direction of the plurality of actuators extends along a first axis (z).

6. The method according to claim 1, wherein the optical element (1) is a liquid lens or an adjustable window element.

7. The method according to claim 1, wherein the plurality of actuators is arranged along a circumference portion (200) of a clear aperture (300) of the optical element (1).

8. The method according to claim 7, wherein one or more shaping elements (5) are arranged along said circumference portion (200), wherein the actuators are configured to move or deform said one or more shaping elements for adjusting the optical element (1).

9. The method according to claim 5, wherein in the adjusted state of the optical element, a contour of the one or more shaping elements varies along the first axis in the adjusted state of the optical element.

10. The method according to claim 1, wherein one or more actuators, particularly all actuators exhibit a load and/or an actuation position dependent actuation force characteristic, particularly wherein the actuation force is non-linear with respect to the load and/or the actuation position.

11. The method according to claim 1, wherein the restoring force is non-Hookean, i.e. non-linear-elastic.

12. The method according to claim 1, wherein all restoring forces acting on the actuators are coupled via the optical element, in particular via the one or more shaping elements, such that the actuators collaboratively work against the coupled restoring forces at least during the first actuation phase.

13. The method according to claim 1, wherein a holding force of each actuator is higher than a highest achievable actuation force of each actuator.

14. The method according to claim 1, wherein the optical element (1) is a membrane-based fluid lens, wherein in the first actuation phase, particularly only in the first actuation phase, a sphere power of the fluid lens is adjusted, wherein in the second actuation phase, particularly only in the second actuation phase, a cylinder power of the fluid lens id adjusted.

15. A computer program comprising computer program code, wherein when executed on a data processing system, the computer program causes the data processing system to execute the method according to claim 1, particularly by causing the data processing system to issue control signals configured to drive the actuators according to the method.

16. An adjustable optical system (10), comprising:
an optical element (1) with a plurality of actuators (11 to 18),
a base frame (2),
at least one restoring force generative element (3),
wherein the actuators (11 to 18) are arranged to exert an actuation force between the base frame (2) and the at least one restoring force generative element (3),
a control module (4) configured to drive the actuators (11 to 18) according to the method according to claim 1.

17. The system (10) according to claim 16, wherein the control module (4) is connected to a data processing system to receive and to execute control signals from the control module (4), the data processing system having stored a computer program comprising a computer program code, wherein when executed on a data processing system, the computer program causes the data processing system to execute the method by causing the data processing system to issue control signals.

18. The system according to claim 16, wherein the at least one restoring force generative element (3), comprises a bellows and/or one or more elastically deformable membrane(s).

19. The system according to claim 16, wherein the plurality of actuators is arranged along a circumference portion (200) of a clear aperture (300) of the optical element (1).

20. The system according to claim 19, wherein the system comprises one or more shaping elements (5) that are arranged along the circumference portion (200) of the clear aperture (300), wherein the one or more shaping element(s) is/are in contact with the actuators.

21. The system according to claim 16, wherein the system (10) comprises an elastically deformable membrane covering a fluid core (6), particularly liquid core, wherein the system is configured to adjust a shape of the elastically deformable membrane (3) with the actuators, particularly by means of moving and/or deforming the one or more shaping elements, thereby adjusting an optical property of the optical element (1).

22. The system according to claim 20, wherein the one or more shaping element(s) (5) is/are attached to the elastically deformable membrane (3) at the circumference portion of the clear aperture.

23. The system according to claim 21, wherein the system comprises a fluid lens comprising the elastically deformable membrane, wherein said membrane is adjustable with the actuators for adjusting an optical property, such as an optical power of the fluid lens.

24. The system according to claim 16, wherein the system comprises one or more inhibition elements that is/are configured to generate a holding force, wherein each inhibition element is configured to lock an associated actuator in an end position or in the first position and to sustain a holding force at said position.
